(19) United States
(12) Patent Application Publication
(10) Pub. No.: US 2013/0286210 A1
(43) Pub. Date: Oct. 31, 2013

(54) Bird-View Image Capture System and Bird-View Image Capture Method Thereof

(71) Applicants: Chih-Huan Wu, Kaohsiung City (TW); Chung-Fang Chien, Taipei City (TW); Ching-Shyang Lo, Hsinchu City (TW)

(72) Inventors: Chih-Huan Wu, Kaohsiung City (TW); Chung-Fang Chien, Taipei City (TW); Ching-Shyang Lo, Hsinchu City (TW)

(73) Assignee: ALTEK AUTOTRONICS CORP., Hsinchu (TW)

(21) Appl. No.: 13/491,889

(22) Filed: Jun. 8, 2012

(30) Foreign Application Priority Data
Apr. 27, 2012 (TW) 101115272

(51) Int. Cl. H04N 7/18

(52) U.S. Cl. 348/159; 348/E07.085

(57) ABSTRACT

A bird-view image capture system and a bird-view image capture method thereof. The system comprises a plurality of image capture modules, a processing module, a compositing module and a display module. Therein, each of the plurality of image capture modules captures an image respectively. The processing module analyzes the plurality of images to get a plurality of first images and a plurality of second images. The processing module converts the plurality of first images and the plurality of second images respectively to get a plurality of inboard images and a plurality of outboard images. The compositing module composes the plurality of inboard images and the plurality of outboard images as a plurality of compositing images. The compositing module composes each compositing image to produce a bird-view image. The display module displays the bird-view image.

### CROSS-REFERENCE TO RELATED APPLICATION

This application claims priority from Taiwan Patent Application No. 101115272, filed on Apr. 27, 2012, in Taiwan Intellectual Property Office, the contents of which are hereby incorporated by reference in their entirety for all purposes.

### BACKGROUND OF THE INVENTION

1. Field of the Invention

The present invention relates to an automobile bird-view image capture system and a bird-view image capture method thereof, and more particularly to the bird-view image capture system and method capable of reducing image deformation, restoring stereoscopic sense, and enhancing field of view.

2. Description of Related Art

A 2D bird-view system is an external image capture device generally installed on an outer side of a car body for capturing images, and a linear conversion is provided for converting all images into a screen of planar coordinates on the ground. However, a conventional system still projects the converted images onto the ground even if there are 3D objects in the environment, so that the converted 3D objects will be spread outwardly and deformed. In the meantime, when the 2D bird-view system converts the images, a constant conversion ratio is adopted regardless of the coordinates of a near or far object, such that when images of a larger range are displayed, the screens near the user are displayed insufficiently, and the screens far from the user are displayed excessively.

Although the present existing 3D bird-view systems do not have the aforementioned situations including the deformed objects, mirrored images similar to those produced by a convex mirror are formed. In other words, curves of different curvatures will be formed after a straight line on the ground in the environment is converted into a bird-view image. Therefore, when the user is driving a car, the car will be like to be driven on a sphere with a convex surface. When the car body is moving, the screen will be moved accordingly, so as to produce dizziness to the driver, and the driver will be unable to view the screen easily. In the meantime, the 3D bird-view system also has the same problems as the 2D bird-view system, wherein when a constant conversion ratio is used for displaying images in a larger display range, the information of an image at a near position is displayed too little, but the information of an image at a far position is displayed too much.

Therefore, it is a main subject for related manufacturers to design a bird-view image capture system and a bird-view image capture method to process images at near and far positions by different conversion and compression methods and obtain highly recognized screen images, while enhancing the level of recognition of outside 3D objects.

### SUMMARY OF THE INVENTION

In view of the aforementioned problems of the prior art, it is a primary objective of the invention to provide a bird-view image capture system and a bird-view image capture method capable of improving the field of view of a bird-view image while maintaining the high resolution of images near a car.

To achieve the foregoing objective, the present invention provides a bird-view image capture system, comprising a plurality of image capture modules, a processing module, a composing module and a display module. Each of the image capture modules captures an image. The processing module analyzes the images to obtain a plurality of first images and a plurality of second images and converts each of the first images and each of the second images according to a first conversion parameter and a second conversion parameter to obtain a plurality of inboard images and a plurality of outboard images. The composing module composes the plurality of inboard images and the plurality of outboard images into a plurality of compositing images and composes each of the compositing images to produce a bird-view image. The display module displays the bird-view image.

Wherein, the processing module analyzes the image by using a preset pixel as a boundary, and individually obtains the plurality of first images and the plurality of second images corresponding to each of the images upon the boundary.

Wherein, the processing module performs a linear conversion or a compression conversion of the plurality of first images to obtain the plurality of inboard images.

Wherein, the processing module performs an asymptotic compression conversion of the plurality of second images to obtain the plurality of outboard images.

Wherein, the bird-view image comprises a characteristic image which acts as the center of the bird-view image.

Wherein, the composing module composes the plurality of inboard images and the plurality of outboard images on a side of the characteristic image to form the bird-view image.

Wherein, the processing module analyzes a boundary of the image to obtain a third image, and performs a conversion of the third image according to a third conversion parameter to obtain a boundary image.

To achieve the aforementioned objective, the present invention further provides a bird-view image capture method applied in a bird-view image capture system, and the bird-view image capture system comprising a plurality of image capture modules, a processing module, a composing module and a display module, and the bird-view image capture method comprising the steps of: capturing an image individually through the plurality of image capture modules; analyzing the images by the processing module to obtain a plurality of first images and a plurality of second images; performing a conversion of each of the first images and each of the second images according to a first conversion parameter and a second conversion parameter respectively by the processing module to obtain a plurality of inboard images and a plurality of outboard images; composing the plurality of inboard images and the plurality of outboard images into a plurality of compositing images by the composing module; composing each of the compositing images to produce a bird-view image by the composing module; and displaying the bird-view image through the display module.

In summation, the bird-view image capture system and method the present invention have one or more of the following advantages:

(1) The bird-view image capture system and method the present invention can overcome the drawback the prior art that has an externally-spread deformation of a screen easily, wherein the information of an image at a near position is displayed too little, and the information of an image at a far position is displayed too much, while a 3D screen is displayed.

(2) The bird-view image capture system and method the present invention can overcome the drawback of the prior art that causes dizziness to users while a 3D screen is displayed, since the screens have different curvatures.

(3) The bird-view image capture system and method the present invention can maintain sufficient information for images at a near position and having a close relation with the users, and also can improve the recognition of the outside 3D objects, so as to provide 2D or 3D bird-view images to the users effectively.

The technical contents and characteristics of the present invention will be apparent with the detailed description of a preferred embodiment accompanied with related drawings as follows.

### BRIEF DESCRIPTION OF THE DRAWINGS

FIG. 1 is a block diagram of a bird-view image capture system of the present invention;

FIG. 2 is a first schematic view of a bird-view image capture system in accordance with a first preferred embodiment of the present invention;

FIG. 3 is a second schematic view of a bird-view image capture system in accordance with the first preferred embodiment of the present invention;

FIG. 4 is a third schematic view of a bird-view image capture system in accordance with the first preferred embodiment of the present invention;

FIG. 5 is a flow chart of a bird-view image capture method in accordance with the first preferred embodiment of the present invention;

FIG. 6A is a first schematic view of a bird-view image capture system in accordance with a second preferred embodiment of the present invention;

FIG. 6B is a second schematic view of a bird-view image capture system in accordance with the second preferred embodiment of the present invention;

FIG. 7 is a third schematic view of a bird-view image capture system in accordance with the second preferred embodiment of the present invention; and

FIG. 8 is a flow chart of a bird-view image capture method in accordance with the second preferred embodiment of the present invention.

### DETAILED DESCRIPTION OF THE PREFERRED EMBODIMENTS

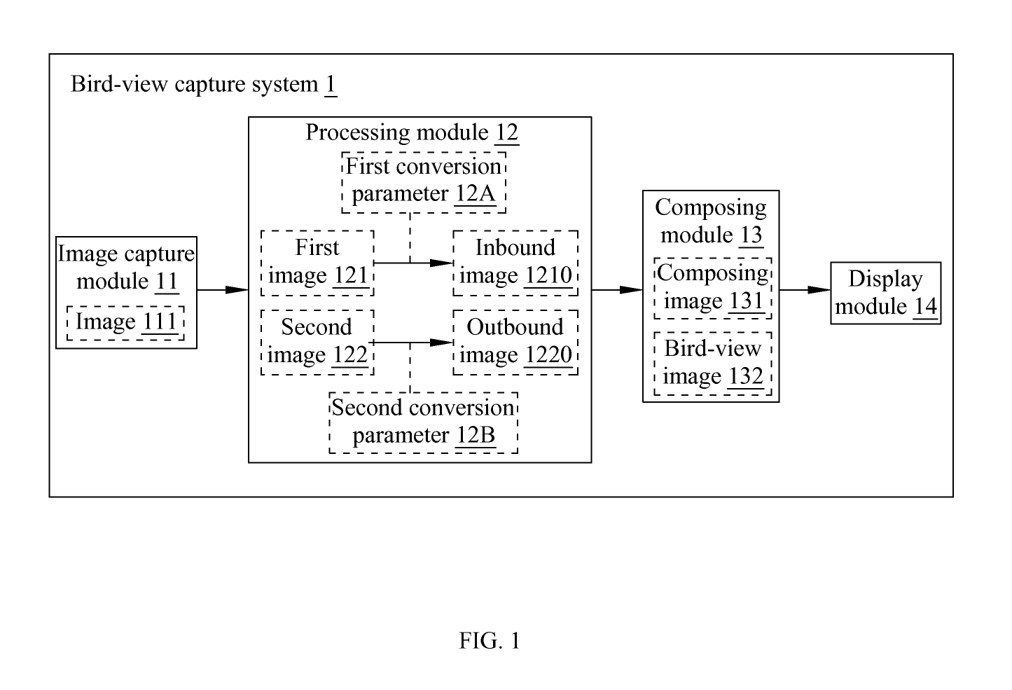

With reference to FIG. 1 for a block diagram of a bird-view image capture system of the present invention, the bird-view image capture system 1 comprises a plurality of image capture modules 11, a processing module 12, a composing module 13 and a display module 14. Each of the image capture modules 11 captures an image 111, wherein the image capture modules 11 can be a camera lens, a sensor such as a complementary metal oxide semiconductor (CMOS) sensor or a charge coupled device (CCD) sensor, an analog/digital circuit, or an image processor. The processing module 12 analyzes the images 111 to obtain a plurality of first images 121 and a plurality of second images 122, and performs a conversion of the plurality of first images 121 and the plurality of second images 122 according to a first conversion parameter 12A and a second conversion parameter 12B to obtain a plurality of inboard images 1210 and a plurality of outboard images 1220, wherein the processing module 12 can be a central processing unit (CPU) or a micro-processing unit. The composing module 13 composes each inboard image 1210 and each outboard image 1220 into a plurality of compositing images 131, and composes the plurality of compositing images 131 to produce a bird-view image 132. The display module 14 displays the bird-view image 132, wherein the display module 14 is a liquid crystal display (LCD) or a touch LCD panel.

The first preferred embodiment is described below to further illustrate the technical characteristics of the present invention, wherein the image capture module is installed on a car body for the illustration, but the invention is not limited to such arrangement only.

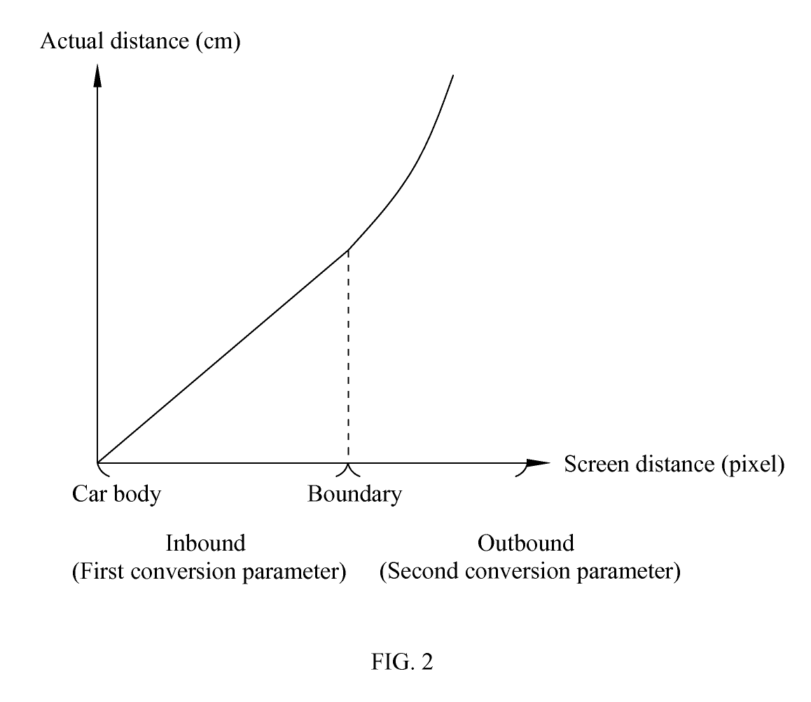

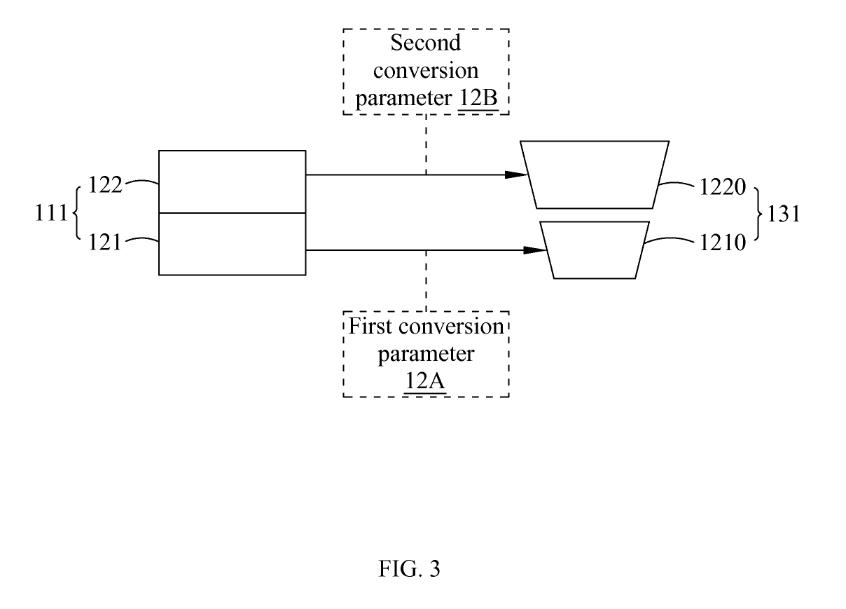

Refer to FIGS. 2 and 3 for the first and second schematic views of a bird-view image capture system in accordance with a first preferred embodiment of the present invention respectively. In general, a 2D bird-view image displayed by the prior art usually provides insufficient information of an inboard image near the car body and excessive information of an outboard image far from the car body on the screen, or the outboard image occupies a large portion of the screen. As a result, the system provides too little information that the users want and too much information that the users do not care about. In the first preferred embodiment as shown in FIG. 2, the processing module can analyze the images by using a preset pixel in the screen as a boundary for analyzing the images, and obtain a first image and a second image corresponding to each image. In other words, a car body is referred as the center, and the processing module can analyze an image from the car body to a boundary point which is the first image, and an image from the boundary point to an infinitely far position which is the second image.

Further, the inboard image is usually the part that a driver cares, and the outboard image is primarily used for assisting the driver to observe the driving condition at a farther distance. As the distance is farther, only the bigger objects are concerned. In FIGS. 2 and 3, after the processing module analyzes the image 111 to obtain the first image 121 and the second image 122, the processing module users the first conversion parameter 12A (such as the linear compression or a low compression ratio) to perform a conversion of the first image 121 to obtain an inboard image 1210, so that sufficient resolution can be maintained for the driver to recognize the road conditions at a near distance. In addition, the processing module uses a second conversion parameter 12B (such as an asymptotic compression ratio) to convert the second image 122 to obtain an outboard image 1220. In other words, if the compression ratio of an external side is large, the field of view can be improved and the recognition of the outside 3D objects can be enhanced.

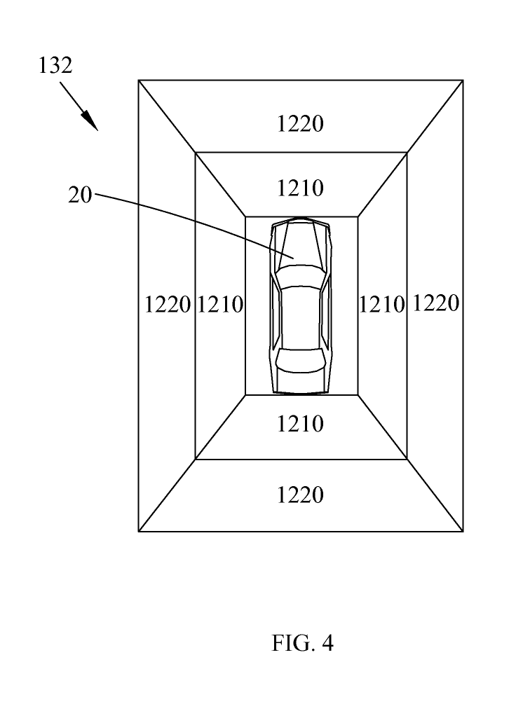

With reference to FIG. 4 for a third schematic view of a bird-view image capture system in accordance with the first preferred embodiment of the present invention, a bird-view image 132 comprises a characteristic image, which is the image of a car body 20, and can be used as the center of the bird-view image 132. When the processing module converts each of the first images and each of the second images according to a first conversion parameter and a second conversion parameter to obtain an inboard image 1210 and an outboard image 1220, the composing module composes the inboard image 1210 and the outboard image 1220 into a compositing image. In addition, the composing module composes the compositing images of the inboard images 1210 and the outboard images 1220 to a side of the image of the car body 20 to form the bird-view image 132.

It is noteworthy that the processing module preferably performs a linear conversion or a linear compression to convert the first image to obtain the inboard image 1210; and preferably perform an asymptotic compression or a high compression to convert the second image to obtain the outboard image 1220.

In the description above, the processing module is not limited to obtaining the first image and the second image only, but the processing module also can obtain more than two images provided for further compression and conversion. Wherein, the outboard image can be formed by converting the second image, and the invention is not limited to such arrangement only. The processing module can obtain a plurality of images and produce a conversion parameter for each image according to the procedure of the second image to produce a multi-layer outboard image. In addition, the composing module not only composes images on the inner and outer sides only, but also composes two or more images on a side of the characteristic image to form a multi-layered bird-view image.

Even though the concept of the bird-view image capture method of the present invention has been described in the section of the bird-view image capture system of the present invention, the following description of a flow chart is provided for illustrating the invention more clearly.

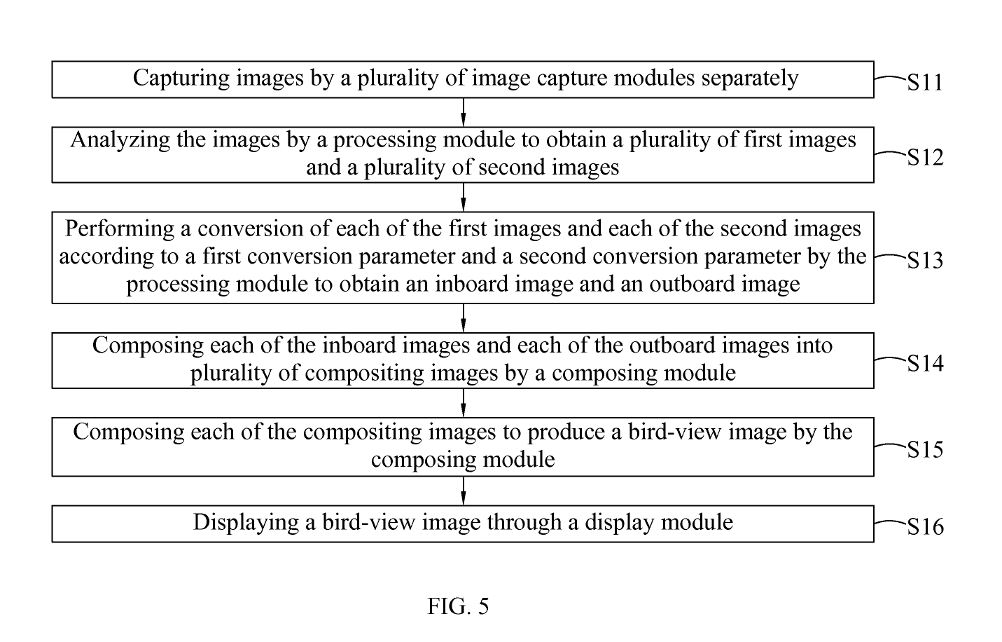

With reference to FIG. 5 for a flow chart of a bird-view image capture method of the present invention, the bird-view image capture method is applied in a bird-view image capture system, and the details and implementation of the bird-view image capture system have been described above, and thus will not be repeated. In FIG. 5, the bird-view image capture method of the bird-view image capture system comprises the following steps:

S11: Capturing images by a plurality of image capture modules separately.

S12: Analyzing the images by a processing module to obtain a plurality of first images and a plurality of second images.

S13: Performing a conversion of each of the first images and each of the second images according to a first conversion parameter and a second conversion parameter by the processing module to obtain an inboard image and an outboard image.

S14: Composing each of the inboard images and each of the outboard images into plurality of compositing images by a composing module.

S15: Composing each of the compositing images to produce a bird-view image by the composing module.

S16: Displaying a bird-view image through a display module.

The details and implementation of the bird-view image capture method of a bird-view image capture system of the present invention have been described in the section of the bird-view image capture system of the present invention, and thus will not be repeated.

Based on the first preferred embodiment, a second preferred embodiment is further provided for illustrating the present invention.

The second preferred embodiment is described below to further illustrate the technical characteristics of the present invention, wherein the image capture module is installed on a car body for the illustration, but the invention is not limited to such arrangement only.

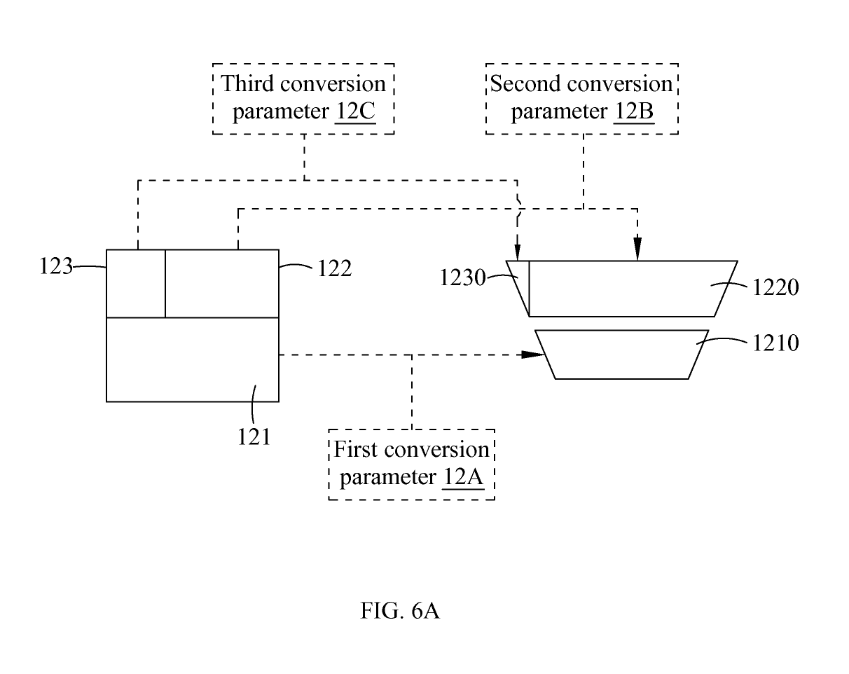

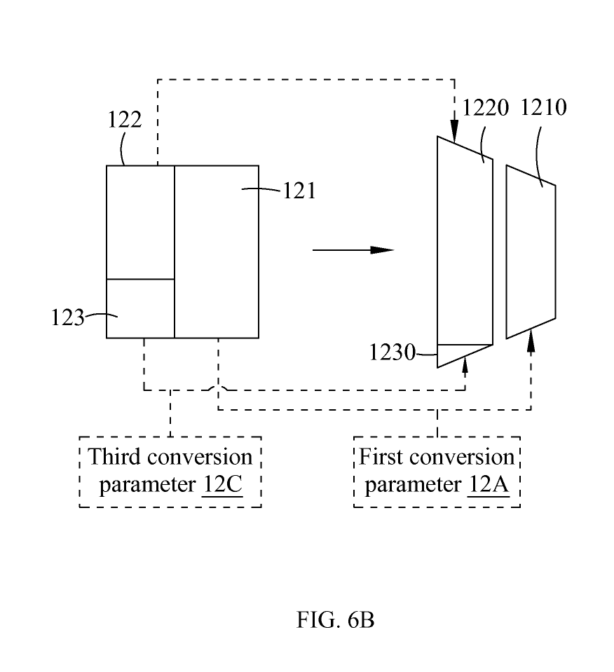

With reference to FIGS. 6A and 6B for the first and second schematic views of a bird-view image capture system in accordance with the second preferred embodiment of the present invention respectively, the first image 121, the second image 122 and the third image 123 on the left side of FIG. 6A are images captured from the front side of the car body, and the first image 121, the second image 122 and the third image 123 on the left side of FIG. 6B are images captured from the left side of the car body.

To maintain the original 3D visual effect of the 3D objects of the outboard image as shown in the figures in order to enhance the recognition of 3D barriers, the processing module analyzes a boundary of the images to obtain a third image 123, and converts the third image 123 according to the third conversion parameter 12C to obtain a boundary image 1230. In FIGS. 6A and 6B, the processing module can perform a conversion of the first image 121 by a linear compression or a low compression ratio to obtain an inboard image 1210, and the processing module can perform an asymptotic compression or conversion of the second image 122 to obtain an outboard image 1220. It is noteworthy that a third conversion parameter 12C can be set for the boundary portion of the image as needed. The processing module can convert the third image 123 according to the third conversion parameter 12C to obtain a boundary image 1230. Therefore, the portion of an edge or a boundary of an image can be maintained to have a continuous contour.

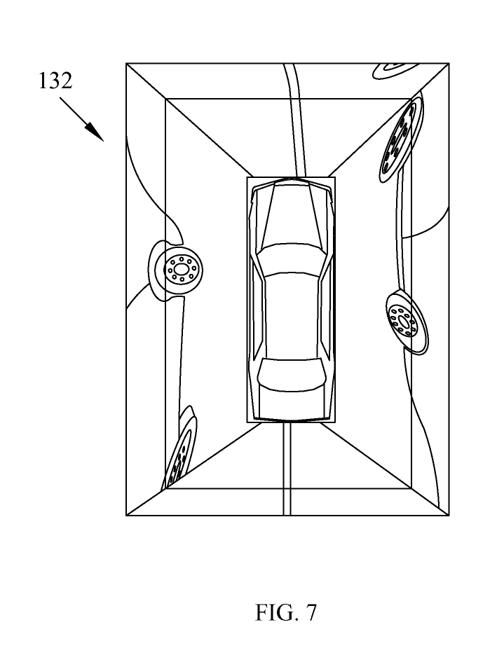

With reference to FIG. 7 for the third schematic view of a bird-view image capture system in accordance with the second preferred embodiment of the present invention, the center of the bird-view image 132 is the car body. When the processing module converts the first image, the second image and the third image according to a first conversion parameter, a second conversion parameter and a third conversion parameter respectively to obtain an inboard image, an outboard image and a boundary image, the composing module can compose the inboard image and the outboard image into a compositing image, and then the composing module composes the composing images with the inboard image and the outboard image on a side of the characteristic image to form the bird-view image 132.

Even though the concept of the bird-view image capture method of the present invention has been described in the section of the bird-view image capture system of the present invention, the following description of a flow chart is provided for illustrating the invention more clearly.

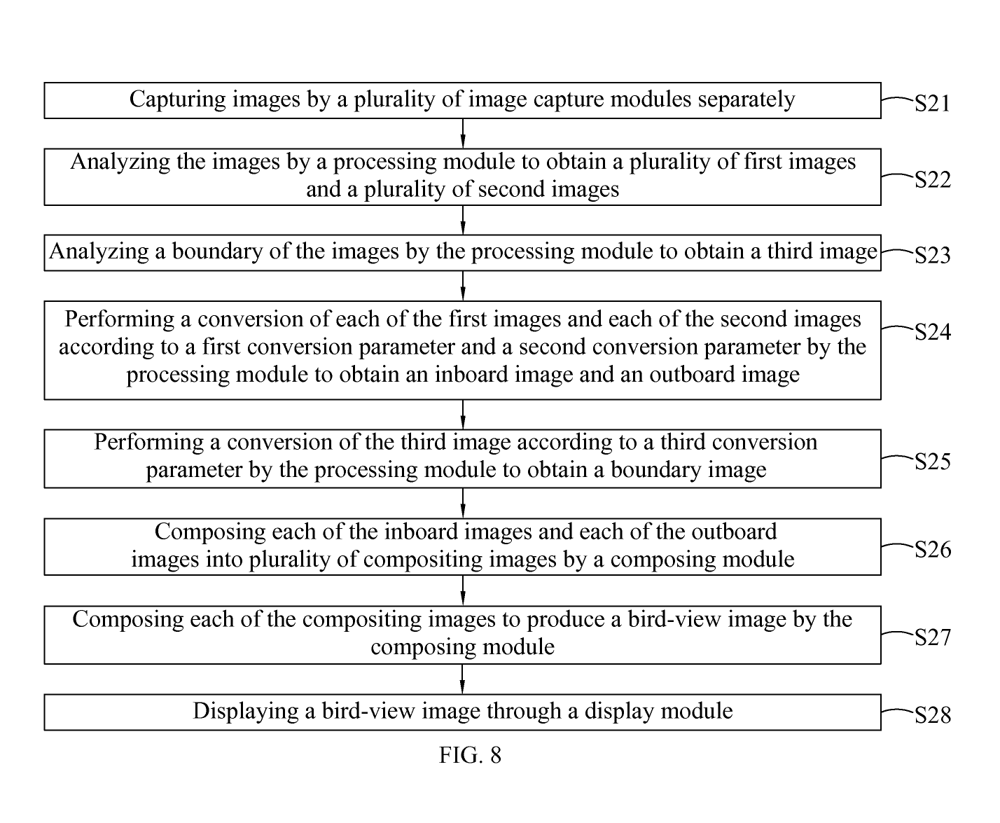

With reference to FIG. 8 for a flow chart of a bird-view image capture method in accordance with the second preferred embodiment of the present invention, the bird-view image capture method is applied in the bird-view image capture system, wherein the bird-view image capture system has been described in details above, and thus will not be repeated. In FIG. 8, the bird-view image capture method of the bird-view image capture system comprises the following steps:

S21: Capturing images by a plurality of image capture modules separately.

S22: Analyzing the images by a processing module to obtain a plurality of first images and a plurality of second images.

S23: Analyzing a boundary of the images by the processing module to obtain a third image.

S24: Performing a conversion of each of the first images and each of the second images according to a first conversion parameter and a second conversion parameter by the processing module to obtain an inboard image and an outboard image.

S25: Performing a conversion of the third image according to a third conversion parameter by the processing module to obtain a boundary image.

S26: Composing each of the inboard images and each of the outboard images into plurality of compositing images by a composing module.

S27: Composing each of the compositing images to produce a bird-view image by the composing module.

S28: Displaying a bird-view image through a display module.

The details and implementation of bird-view image capture method of a bird-view image capture system of the present invention have been described in the section of the bird-view image capture system of the present invention, and thus will not be repeated.

While the invention has been described by means of specific embodiments, numerous modifications and variations could be made thereto by those skilled in the art without departing from the scope and spirit of the invention set forth in the claims.

What is claimed is:

1. A bird-view image capture system, comprising:
a plurality of image capture modules, each capturing an image;
a processing module, analyzing the images to obtain a plurality of first images and a plurality of second images, and converting each of the first images and each of the second images according to a first conversion parameter and a second conversion parameter to obtain a plurality of inboard images and a plurality of outboard images;
a composing module, composing the plurality of inboard images and the plurality of outboard images into a plurality of compositing images, and composing each of the compositing images to produce a bird-view image; and
a display module, displaying the bird-view image.

2. The bird-view image capture system of claim 1, wherein the processing module analyzes the image by using a preset pixel as a boundary, and individually obtains the plurality of first images and the plurality of second images corresponding to each of the images upon the boundary.

3. The bird-view image capture system of claim 1, wherein the processing module performs a linear conversion or a compression conversion of the plurality of first images to obtain the plurality of inboard images.

4. The bird-view image capture system of claim 1, wherein the processing module performs an asymptotic compression conversion of the plurality of second images to obtain the plurality of outboard images.

5. The bird-view image capture system of claim 1, wherein the bird-view image comprises a characteristic image which acts as a center of the bird-view image.

6. The bird-view image capture system of claim 5, wherein the composing module composes the plurality of inboard images and the plurality of outboard images on a side of the characteristic image to form the bird-view image.

7. The bird-view image capture system of claim 1, wherein the processing module analyzes a boundary of the image to obtain a third image, and performs a conversion of the third image according to a third conversion parameter to obtain a boundary image.

8. A bird-view image capture method, applied in a bird-view image capture system, and the bird-view image capture system comprising a plurality of image capture modules, a processing module, a composing module and a display module, and the bird-view image capture method comprising the steps of:
capturing an image individually through the plurality of image capture modules;
analyzing the images by the processing module to obtain a plurality of first images and a plurality of second images;
performing a conversion of each of the first images and each of the second images according to a first conversion parameter and a second conversion parameter respectively by the processing module to obtain a plurality of inboard images and a plurality of outboard images;
composing the plurality of inboard images and the plurality of outboard images into a plurality of compositing images by the composing module;
composing each of the compositing images to produce a bird-view image by the composing module; and
displaying the bird-view image through the display module.

9. The bird-view image capture method of claim 8, further comprising the step of:
analyzing the images by using a preset pixel as a boundary for analyzing the images by the processing module, and individually obtaining the plurality of first images and the plurality of second images corresponding to each of the images.

10. The bird-view image capture method of claim 8, further comprising the step of:
performing a linear conversion of the plurality of first images by the processing module to obtain the plurality of inboard images.

11. The bird-view image capture method of claim 8, further comprising the step of:
performing an asymptotic compression conversion of the plurality of second images by the processing module to obtain the plurality of outboard images.

12. The bird-view image capture method of claim 8, wherein the bird-view image comprises a characteristic image which acts as a center of the bird-view image.

13. The bird-view image capture method of claim 12, further comprising the step of:
using the composing module to compose the plurality of inboard images and the plurality of outboard images at a side of the characteristic image to form the bird-view image.

14. The bird-view image capture method of claim 8, further comprising the steps of:
analyzing a boundary of the image by the processing module to obtain a third image; and
performing a conversion of the third image according to a third conversion parameter by the processing module to obtain a boundary image.
